(19) United States
(12) Patent Application Publication
(10) Pub. No.: US 2009/0204673 A1
(43) Pub. Date: Aug. 13, 2009

(54) METHOD, SYSTEM AND APPARATUS FOR PERFORMING MULTI-PARTY COMMUNICATIONS AND METHOD FOR PUBLISHING EVENT STATE

(75) Inventors: Linyi TIAN, Shenzhen (CN); Qian SUN, Shenzhen (CN); Yang ZHAO, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/423,997

(22) Filed: Apr. 15, 2009

Related U.S. Application Data
(63) Continuation of application No. PCT/CN2008/070086, filed on Jan. 11, 2008.

(30) Foreign Application Priority Data
Feb. 1, 2007 (CN) 200710006442.7

(51) Int. Cl. G06F 15/16

(52) U.S. Cl. 709/204

(57) ABSTRACT

The present invention discloses a method, a system and an apparatus for performing multi-party communication and a method for publishing event state. The method for performing multi-party communication includes: receiving a multi-party communication requests carrying the group condition of a current multi-party communication; according to the group condition of the current multi-party communication obtained from the request, controlling the current multi-party communication. The method, system and apparatus provided in the embodiment of the present invention may set the group condition of the multi-party communication to regulate participants of the multi-party communication by the group condition. The method for publishing event state provided in the present invention includes: after receiving the event state of the carried resource and the publishing message of authorization information, controlling the subscription authorization of the event state of the resource according to the authorization information. The method can perform subscription regulation for the event state.

### CROSS-REFERENCE TO RELATED APPLICATIONS

This application is a continuation of International Patent Application No. PCT/CN2008/070086, filed Jan. 11, 2008, which claims priority to Chinese Patent Application No. 200710006442.7, filed Feb. 1, 2007, both of which are hereby incorporated by reference in their entirety.

### FIELD OF THE TECHNOLOGY

The present invention relates to a multi-party communication technique in the communication field, particularly to a method, a system and an apparatus for performing multi-party communications and a method for publishing event states.

### BACKGROUND

With the development of session initiation protocol (SIP) techniques, it is getting more and more popular to perform multi-party communications, for example, performing a multi-party conference including the types of media such as videos, voices or texts in the communication domain. Many communication services can support multi-party communication, such as Instant Messaging (IM) service and Push-To-Talk over cellular (PoC) and so on. The multi-party communication mainly refers to a centralized conferencing with an application server performing centralized controlling over the multi-party communication. Depending on the type of participants, the multi-party communication is mainly divided into two modes: a pre-defined group mode and a temporary group (Ad hoc Group) mode.

In the pre-defined group mode, a pre-defined group includes a group member list. A group identity (ID) is used to identify this group. On initiating the multi-party communication by using an SIP invite message, an initiator sends the SIP INVITE message carrying the group ID to an application server of multi-party communication in order to request to establish multi-party communication. The application server stores the relationship between the group ID and the group member list. According to the relationship, the group member list corresponding to the group ID carried in the received message is determined. The message is sent to each member within the group member list. After determining group members, the application server establishes the multi-party communication between the initiator and each member within the group member list.

In the temporary group mode, since the application server does not store the relationship between the group ID and the group member list, therefore when the initiator sends the SIP INVITE message to the application server requesting to establish multi-party communication, the SIP INVITE message needs to carry the group member list of the temporary group. After the application server receives the message, the application server transfers the request to each member within the carried group member list. After determining group members, the application server establishes the multi-party communication between the initiator and each member within the group member list.

In the specification developed by Internet Engineering Task Force (IETF), the message body of the SIP message may include the group member list of the temporary group in order to invite many members to participate in the multi-party communication. Specifically, the SIP INVITE message contains a multipart/mixed message body including two specific message body parts: one is an application/sdp message body for describing the multi-party communication, e.g., the media of a session; another one is an application/resource-lists+xml message body for describing the list of uniform resource identifier (URI) of members participating in the multi-party communication.

The following description is performed taking a multi-party communication session as an example.

FIG. 1 is a flowchart illustrating the method for establishing a session by adopting SIP technique in conventional technology. The included network entity is a session initiator, an application server (may be IM, PoC or phone conference server and so on) and many session participants. The specific steps are as follows.

Step 101, the session initiator initiates an SIP INVITE request carrying a multipart/mixed message body to the application server.

Step 102, the application server receiving the request returns an acknowledgement message, i.e., 200 OK response, to the session initiator.

Step 103, the application server determines the session participants according to the temporary group member list in the multipart/mixed message body carried in the request and sends SIP INVITE requests to the session participants respectively. The request is similar to the request in the step 101 both containing the multipart/mixed message body with the difference that the multipart/mixed message body does not contain the temporary group member list.

For simplicity, some well-known message flow steps, e.g., ACK response, are omitted in the figure.

In the practical establishment of a multi-party communication, the session initiator of the multi-party communication hopes to set a regulation for participants. The regulation may be called the group session condition (Conference Policy or Group Rules) or the group condition for short. For example, a maximum member number of the group in multi-party communication, allowing a member to invite other members for participation or not, allowing other members to proactively participate and/or anonymity or not, etc. However, it can be seen from the above solution that, when the temporary group mode is adopted to establish the multi-party communication, the need can not be met through the existing SIP message, e.g., an SIP INVITE request or an SIP SUBSCRIBE TO request. In addition, when the pre-defined group mode is adopted to establish the multi-party communication, the preset group condition can not be modified in the application server through the existing SIP message.

Furthermore, when two modes are adopted to establish a multi-party communication, the members in the group also have needs of obtaining the group condition for themselves by way of subscription. Currently, these needs can not be met by the existing SIP message.

### SUMMARY

The embodiment of the present invention provides a method for performing multi-party communication. The method can set the group condition of multi-party communication so as to control the multi-party communication and regulate the participants of the multi-party communication through the group condition.

The embodiment of the present invention further provides a system for performing multi-party communication. The system can set the group condition of multi-party communication so as to control the multi-party communication and regulate the participants of the multi-party communication through the group condition.

The embodiment of the present invention further provides a server for performing multi-party communication. The server can set the group condition of the multi-party communication according to the received SIP message so as to control the multi-party communication and regulate the participants of the multi-party communication through the group condition.

The embodiment of the present invention further provides a client for performing multi-party communication. The client can receive the group condition from the incoming SIP message for initiating the multi-party communication, so as to control the multi-party communication and regulate the participants of the multi-party communication through the group condition.

The embodiment of the present invention further provides a method for publishing event state. The method can perform regulation to event state subscription.

The implementing solutions of the embodiments of the present invention are as follows.

A method for performing multi-party communication includes: receiving a multi-party communication requests carrying a group condition of current multi-party communication, and performing controlling over the current multi-party communication according to the group condition of the current multi-party communication obtained from the multi-party communication requests.

A system for performing multi-party communication includes: an application server and a client, in which (1) the application server is adapted to receive a multi-party communication requests sent by the client; obtain a group condition in the multi-party communication requests; after establishing a multi-party communication corresponding to the group condition, perform controlling over the multi-party communication session or perform processing a modification multi-party communication requests sent by the client according to the group condition; and (2) the client is adapted to send the multi-party communication requests carrying the group condition or the multi-party communication modification request to the application server.

A client for performing multi-party communication includes: a transceiver module and a group condition generation module, in which (1) the group condition generation module is adapted to generate a group condition of a multi-party communication and send the group condition to the transceiver module; and (2) the transceiver module is adapted to carry the group condition received from the group condition generation module on the multi-party communication requests and send the multi-party communication requests.

A server for performing multi-party communication includes: a transceiver module, a storage group condition module and a control module, in which (1) the transceiver module is adapted to send a carried group condition to the storage group condition module after receiving the multi-party communication requests carrying the group condition; transfer the multi-party communication requests to the control module for processing; and send out the received response message sent by the control module; (2) the storage group condition module is adapted to receive and store the group condition from the transceiver module and provide the group condition for the control module during a multi-party communication process; and (3) the control module is adapted to control the session of the multi-party communication according to the group condition obtained from the storage group condition module.

A method for publishing an event state includes: after receiving a publication message which includes event state of resources and the authorization information, performing controlling over the subscription of the event state of the resources according to the authorization information.

It can be seen from the above mentioned technical solution that, when the embodiment of the present invention initiates establishing multi-party communication, the initiator of the multi-party communication may carry the group condition through the SIP message. The application server is set with the group condition of the multi-party communication so as to control the multi-party communication and regulate the participants of the multi-party communication according to the group condition during the process of establishing the multi-party communication or during the multi-party communication. Therefore, the method, the system, the server and the client provided in the embodiment of the present invention may set the group condition of the multi-party communication so as to control the multi-party communication and regulate the participants of the multi-party communication through the group condition. Furthermore, the embodiment of the present invention may also update the group condition of the multi-party communication in the application server through the SIP message carrying a group condition during the multi-party communication process.

In addition, the method for publishing event state provided in the embodiment of the present invention may carry authorization information in a publish message so as to perform authorization controlling over the event state of the resource carried in the publish message according to the carried authorization information.

### BRIEF DESCRIPTION OF THE DRAWINGS

FIG. 1 is a flowchart illustrating the method for establishing a session by adopting the SIP technique in the conventional technology;

FIG. 2 is a schematic view illustrating the message body of the application/conference-policy+xml in accordance with the embodiment of the present invention;

FIG. 3 is a flowchart illustrating the method for performing a session under a temporary group mode in accordance with the embodiment of the present invention;

FIG. 4 is a flowchart illustrating the method for the controlling function server to control the session in accordance with the embodiment of the present invention;

FIG. 5 is a flowchart illustrating the method for the participation function server to control the session in accordance with the embodiment of the present invention;

FIG. 6 is a flowchart illustrating the method for a session initiator to modify the group condition in accordance with the embodiment of the present invention;

FIG. 7 is a flowchart illustrating the method for the session participants to subscribe to the group condition in accordance with the embodiment of the present invention;

FIG. 8 is a flowchart illustrating the method for performing a session under the situation of a pre-defined group session and a conference in accordance with the embodiment of the present invention;

FIG. 9 is a flowchart illustrating the method of the processing for the SIP client 2 to send a confidential message to a session establisher in accordance with a preferable embodiment of the present invention;

FIG. 10 is a flowchart illustrating the method for applying for subscribing to presence information in a Publish scene in accordance with the embodiment of the present invention;

FIG. 11 is a schematic view of the system for performing multi-party communication in accordance with the embodiment of the present invention;

FIG. 12 is a schematic view of a client apparatus for performing multi-party communication in accordance with the embodiment of the present invention; and

FIG. 13 is a schematic view of a server apparatus for performing multi-party communication the in accordance with the embodiment of the present invention.

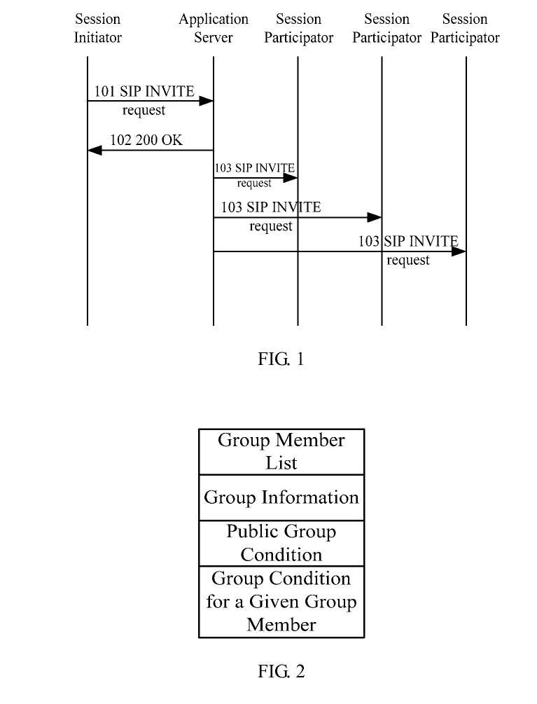

### DETAILED DESCRIPTION

In order to make the objects, technical solutions and merits of the present invention clearer, a further detailed description of embodiments of the present invention is described in more detail with reference to accompanying drawings.

In the embodiment of the present invention, when the initiator in multi-party communication sends a multi-party communication session request to an application server in multi-party communication, a group condition is carried at the same time when group member list information is carried. The group condition includes a public group condition and/or a regulation for a given group member. The application server in multi-party communication determines the members in the group according to the group member list information carried in the received request and sends a corresponding multi-party communication session request to the determined members according to the group condition carried in the received request. After obtaining an acknowledgement response, the members are added into the multi-party communication.

In the embodiment of the present invention, the group member list information carried in the multi-party communication session request may be the identifier of the group member list (under the pre-defined group mode) and the group member list (under the temporary group mode).

In the embodiment of the present invention, in the process of multi-party communication, the group member in multi-party communication may send a modified multi-party communication session request carrying a group condition to the application server in multi-party communication. The application server in multi-party communication determines whether the group condition carried in the received request is matched with the stored group condition. If the two group conditions are matched, the current group condition in multi-party communication may be updated. Furthermore, the updated group condition may be carried in the multi-party communication requests to be sent to the corresponding group members in multi-party communication.

In the embodiment of the present invention, the group members in multi-party communication may also subscribe to the group condition relevant to themselves in multi-party communication so as to be acquainted with their own group condition in the multi-party communication session.

The embodiment of the present invention is described in detail taking the adopting of SIP for establishing multi-party communication as an example.

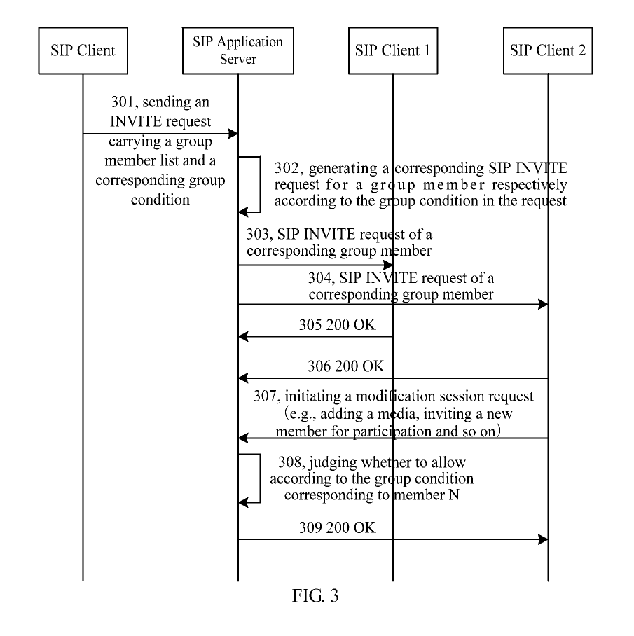

The multi-party communication session request may be an INVITE request for establishing multi-party communication, or a re-INVITE request for modifying the multi-party communication in a session process, or an UPDATE request for modifying the multi-party communication before the session is established, or a reference (REFER) request and so on. The request of INVITE and so on may be sent by a participant in multi-party communication to the application server, or sent by the application server to the participant in multi-party communication. When the initiator in multi-party communication sends the SIP INVITE request to the application server in multi-party communication, the SIP INVITE request contains a multipart/mixed message body including two message body parts: an application/sdp message body for describing the media information of the multi-party communication session and an application/conference-policy+xml message body. The application/conference-policy+xml message body shown as FIG. 2 includes following information items: a group member list, group information, a public group condition for all group members and a group condition for a given group member.

The group member list includes an URI (e.g. Tel URI or SIP URI) of the group member and a corresponding attribute (anonymous or not, etc.).

The group information may be chosen as group information including a group display name <display-name> and a group session subject <subject>.

The public group condition and the group condition for a given group member may be chosen alternatively or coexist. In the practical application, the two group conditions may generally coexist, which include a minimum number of group members <min-participant-count> in multi-party communication for canceling the multi-party communication if the number of group members less than <min-participant-count>; a maximum allowance participant number of group members <max-participant-count> in multi-party communication for not allowing to invite a new member for participation if the number of group members is equal to <max-participant-count>; an end condition <session-end-criteria> in multi-party communication; whether automatically sending a group information modification notice <automatic-group-advertisement>; a maximum duration of the session <max-duration>, an allowable time period <schedule> in multi-party communication; whether setting all the group members in multi-party communication as mute at the beginning <mute-all-first>; a session mode, e.g. identifying whether immediately initiating a session request, i.e., identifying a session as a chat room group session or an instant invitation group session. The above information may be entirely or partially included in the public group condition.

The group condition for a given group member and the public group condition may be chosen alternatively or coexist. The conditions adopt a <conditions>-<actions> structure, i.e. a certain action is executed when a certain condition is fulfilled.

The relevant <conditions> may include: a group member identity <identity> of the multi-party communication, another group member identity <other-identity> of the multi-party communication or/and a temporary group member <is-list-member> of the multi-party communication and so on.

The <actions> defined in the embodiment of the present invention includes: whether allowing group member to subscribe to conference state <allow-conference-state>, whether allowing the group member to subscribe to a multi-party communication participating condition <allow-conference-rule-state>, whether allowing the group member to dynamically invite other users to participate in the session <allow-invite-users-dynamically>, instructing the application server whether to stop the request for participating in the multi-party communication <join-handling>, whether allowing anonymously participating in the multi-party communication <allow-anonymity>, whether owning a member with high priority <is-key-participant>, whether allowing the group member to create a subconference of the multi-party communication <allow-subconf>, whether allowing the group member to use a secret message in the multi-party communication, or/and whether allowing muting all the other group members in the group (allow-mute-all) and so on.

FIG. 3 is a flowchart illustrating the method for performing a session under the temporary group mode in accordance with the embodiment of the present invention. The network entities involved include: a session initiator (i.e., an SIP client), SIP application server, a session participant (i.e., an SIP client 1 and an SIP client 2). The specific steps are as follows.

Step 301, the SIP client sends an SIP INVITE request to the SIP application server. The request carries a temporary group member list and a corresponding group condition adapted to establish the session between the application server and the SIP client.

Step 302, SIP application server generates corresponding SIP INVITE requests for current session participants respectively according to the group condition in the received request.

The message body of the SIP INVITE request generated according to the group condition and corresponding to each current session participant may be different. For example, the SDP part of the message body in the SIP INVITE request generated according to the media type in the group condition allowed by participants may be different. Only voice type communication may be established with part of the participants. Other participants may establish voice type communication and video type communication at the same time. In addition, the SIP application server may also carry a public group condition and a given group condition corresponding to the participant in the message body of the SIP INVITE request sent to each participant. The given group condition corresponding to each participant may also be different.

Step 303, the SIP application server sends the SIP INVITE request corresponding to the SIP client 1 to the SIP client 1. The SIP INVITE request may carry or not carry a group condition corresponding to the SIP client 1.

If the SIP client has received group condition, it may display the content to the users, or control the users according to group condition in follow-up communication process. For example, the group session topic in the group condition is displayed on the interface of the SIP client. Alternatively, the users are not allowed to perform the action not allowed by the group condition, such as establishing a sub conference in multi-party communication. This prevents the client from sending a request not allowed so as to save network resource and time.

Step 304, the SIP application server sends the SIP INVITE request corresponding to the SIP client 2 to the SIP client 2. The SIP INVITE request may carry or not carry the group condition corresponding to the SIP client 2.

Step 305, after the SIP client 1 receives request sent in the step 303, the SIP client 1 returns a response of 200 OK.

After the SIP application server receives the 200 OK, the SIP application server returns an acknowledgement (ACK) response to establish the session with the SIP client 1.

Step 306, after the SIP client 2 receives the request sent in the step 304, the SIP client 2 returns a response of 200 OK.

After the SIP application server receives the 200 OK, the SIP application server returns an ACK response to establish the session with the SIP client 2.

Step 307, the SIP application server establishes the session with the SIP client and the session between the SIP client 1 and SIP client 2, and performs centralized controlling for the group session. During the session process, the group member, e.g. SIP client 1, sends a modification session (re-INVITE) request carrying an update group condition to the SIP application server e.g., adding video media ability or inviting a new group member for participation. The re-INVITE request is actually an SIP INVITE request in the session initiated in the session process. The re-INVITE request may be adapted to modify the attribute of the multi-party communication session, such as the media type, the communication port of the session and so on.

Step 308, the SIP application server judges whether to allow the re-INVITE request sent by the group member according to the stored group condition corresponding to the group member. If it allows, the step 309 is executed; otherwise, a failure response (not shown in figures) is returned.

Step 309, the SIP application server executes the re-INVITE request to add video media ability into the SIP client 1 or initiate the SIP INVITE request to the invited members for inviting the member for participation, and then returns a response, i.e., 200 OK, to the group member sending the modification session request.

During the session process, the group condition may be updated so as to change the centralized control action of the application server. Generally, only the session initiator, such as the above mentioned SIP client or the administrator set in the group condition, e.g., the above mentioned SIP client 1, is allowed to update the group condition. The session initiator may send a re-INVITE message to the application server. The message body of the re-INVITE message carries the updated group condition for substituting or combining the existing condition. The message body may further carry an instruction for instructing whether to perform substitution or combination. The application server may execute the substitution or combination for the group condition according to the instruction. When the SIP application server is executing the modification session request, the SIP application server may also generate a re-INVITE request corresponding to the current session participants according to the modification session request and send the re-INVITE request to the corresponding current session participant including the initiator of the current multi-party communication session. If the group condition is updated to be that the original video conference turns to only allow voice, the application server sends the re-INVITE request to the participant. The message body of the re-INVITE request carries the modified group condition generated for each session participant. If the group condition is updated to forbid the group participant A to participate, the application server may generate a multi-party communication session disconnection request and send it to the group participant A so as to forbid the group participant to participate in the multi-party communication session.

Besides updating the group condition by using the mode of the re-INVITE request during the session process, after sending the SIP INVITE request and before establishing the multi-party communication session, an UPDATE message may used to update the group condition.

The controlling to the multi-party communication session through the group condition is executed by the SIP application server. In the embodiment of the present invention, the SIP application server may be divided into a participation function server and a controlling function server. The modification for the session is centralized on the controlling function server. For the temporary group session, the application server receiving the SIP INVITE session to establish the request at the beginning is treated as the controlling function server. The other application servers participating in the temporary group session are treated as participation function servers. For the pre-defined group session, the application server having the ability to obtain the group member according to group ID may be recognized as the controlling function server and other application servers participating in the pre-defined group session may be recognized as the participation function server. In the embodiment of the present invention, the controlling function server is mainly adapted to process the initial session request, maintain the group session condition, and execute the received modification session request.

In the embodiment of the present invention, the above mentioned SIP application server is actually a controlling function server. The participation function server is transparent to the whole session and does not participate in the controlling for the session according to the group condition.

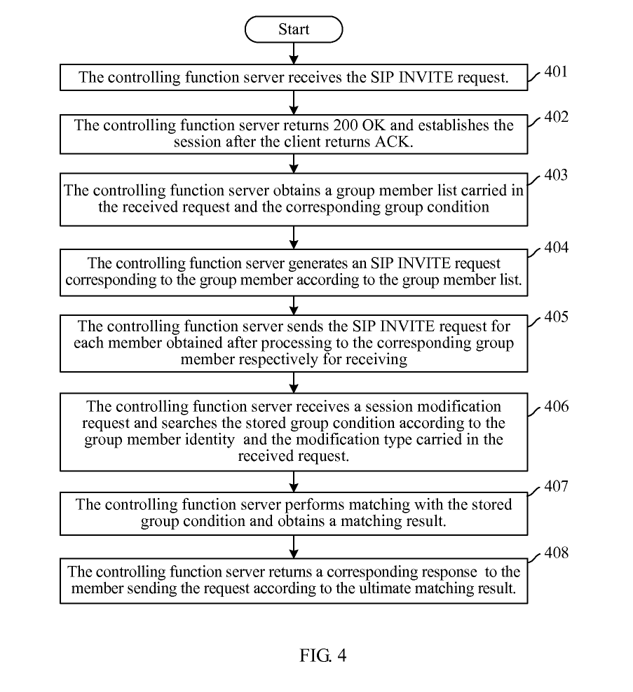

FIG. 4 is a flowchart illustrating the method for to controlling function server to control the session in accordance with the embodiment of the present invention. The specific steps of the method are as follows.

Step 401, the controlling function server receives the SIP INVITE request.

During the temporary group session, the client generally sends an SIP INVITE request to a URI of a preset conference factory (Conf-Factory), i.e., INVITE sip: Conf-Factory. The controlling function server returns 302 (Moved) response, and carries a conference identity (Conf-ID) practically assigned by the controlling function server. The client re-initiates the SIP INVITE request, i.e., INVITE sip: Conf-ID, according to the practically assigned Conf-ID and then establishes the session between the client and the controlling function server.

Step 402, the controlling function server returns 200 OK and establishes the session after the client returns ACK.

Step 403, the controlling function server obtains a group member list and the corresponding group condition carried in the received request.

Step 404, the controlling function server generates an SIP INVITE request corresponding to the group member according to the group member list. The process is: filling the Request URI of the SIP INVITE request to be certain addresses (SIP URI or Tel URI) of a group member, filling the From to be its own address and filling the To be the address of the above mentioned members. The SIP INVITE request may also carry a group condition corresponding to the above mentioned member. However, the currently invited group member may not know some information of the current session, such as the authorization granted to itself and the regulation of the group session and so on.

In the present step, some other processing may also be performed as follows.

A, the controlling function server continues to carry the group member list in the generated message body of the SIP INVITE request corresponding to the group member so as to make the group member know other participants in the group session. However, the URI with “copyControl” being bcc and “anonymous” being true in the received request is deleted. The remained URI is reserved and the INVITE request corresponding to the group member is generated according to the remained SIP. Deleting the URI is to achieve the object of invisibility and confidential transmission for the group member.

B, the controlling function server reserves the public group condition, transforms the group condition for each member into the group condition for the member, and carries the public group condition into the SIP INVITE request corresponding to the group member.

Step 405, the controlling function server sends the obtained SIP INVITE request for each member after processing the corresponding group member respectively for receiving.

In the SIP INVITE request sent to each group member, it may carry the group condition corresponding to the group member and may not carry the group condition corresponding to the group member. If the request carries the group condition, the application server (either the controlling function server or the participation function server) to which the group member belongs or the client where the group member is located may perform some filtering processing when a modification session request is received in the follow-up process. The modification session request may modify the media, send a confidential message and create a sub conference or re-participate in the session so as to prevent the client from sending some not allowed requests to the controlling function server. However, some requests must be processed in the controlling function server, for example, whether the number of group members inviting group members for participation exceeds a present total number of session participants (because the session participants may also invite members for participation, only the controlling function server knows the real-time total number of members).

If the request does not carry a group condition or the group condition in the session process is modified, the application server to which the group member belongs or the client where the group member is located may obtain the group condition by a process of the group member subscribing to the group condition. The process is described in detail as follows.

Step 406, during the session process, if the controlling function server receives a session modification request, which is a request causing session information and state modification for the session, e.g., inviting other members for participation, changing the media type and so on, the controlling function server searches the stored group condition according to the group member identity and the modification type carried in the received request.

Step 407, the controlling function server performs matching with the stored group condition and obtains a matching result.

The specific process may be as follows.

Firstly, the public group condition is applied. For example, the maximum participant of the current session is 10. If there are 10 members currently participating in the session and one of the members adopts a REFER request (a kind of the SIP message) to invite other members for participation, the controlling function server may reject the request.

Then, the group condition for a given group member is applied. The member identity corresponds to the condition in <conditions>; the modification type corresponds to the condition in <actions>. For example, the <conditions>/<identity> in a group condition is the member identity of the member, or the <is-list-member> in the group condition is the member identity of the member, the condition corresponds to the member. Supposedly, the member has ever been kicked out of the current session. The condition of <actions>/<join-handing> is false, i.e., re-participation is not allowed. When the modification type is re-participation, the controlling function server may reject the request.

Step 408, the controlling function server returns a corresponding response including an acceptance request or a rejection request to the member sending the request according to the ultimate matching result.

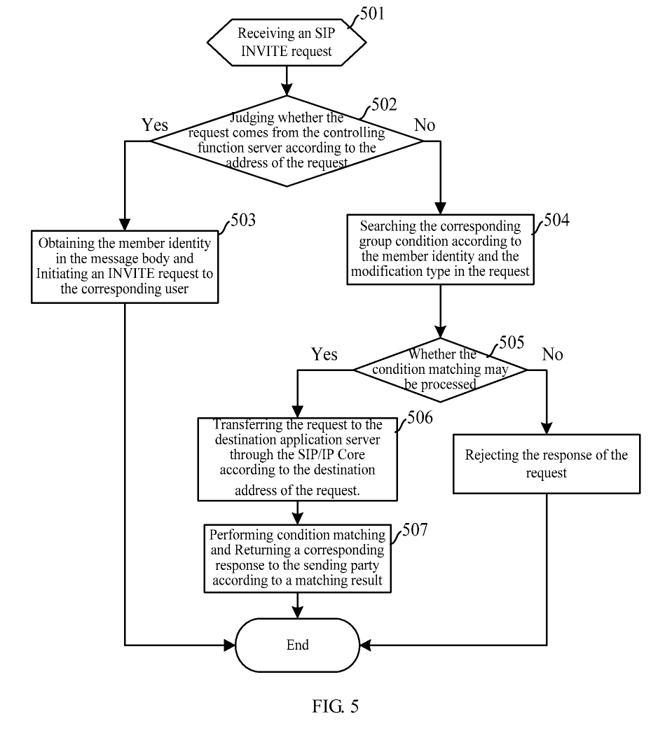

In addition, the participation function server may also perform controlling for the session according to the group condition. Supposedly, the participation function server and the controlling function server are different servers. In practice, if a participant and an initiator belong to the same application server, the participation function server corresponding to the participant is the controlling function server. FIG. 5 is a flowchart illustrating the method for the participation function server to control the session in accordance with the embodiment of the present invention. The specific steps are as follows.

Step 501, the participation function server receives the SIP INVITE request.

Step 502, the participation function server judges whether the received SIP INVITE request comes from the controlling function server. If the SIP INVITE request comes from the controlling function server, the step 503 is executed; otherwise, the step 504 is executed.

Step 503, the participation function server obtains the member identity carried in the received request, sends the SIP INVITE request to the corresponding group member, requests the group member to participate in the session, and ends this flow.

If the SIP INVITE request contains the group condition, the participation function server caches the group condition locally provided for performing filtering processing the participant's requests in follow-up flows.

Step 504, the participation function server obtains the modification type carried in the received request and searches the corresponding group condition cached locally. The step 504 is executed.

In the present step, if the received SIP INVITE request does not come from the controlling function server, this demonstrates that the SIP INVITE request is a modification multi-party communication session request.

Step 505, the participation function server judges whether the modification type is matched with the searched corresponding group condition or whether the participation function server does not store the corresponding group condition. If the modification type is matched with the searched corresponding group condition and the participation function server does not store the corresponding group condition, the step 506 is executed; otherwise, a response is returned to reject the request.

The judging whether the modification type is matched with the searched corresponding group condition is judging whether the modification type is allowed by the group condition. The participation function server may not be able to judge the number of the current session participants. Therefore, the participation function server can not perform a group condition matching processing the modification type of “re-participation” and “inviting other members for participation,” etc. However, the participation function server may perform group condition matching for the modification type of “confidential message” or “obtaining conference state,” etc.

Step 506, the participation function server transfers the request to the destination application server, i.e., the controlling function server, for processing according to the destination address of the received request.

Step 507, the controlling function server performs matching with the group condition and returns a corresponding response including an acceptance of the request or a rejection of the request to the sending party according to the matching result.

In the step, if the controlling function server does not send the group condition to the application server to which the session participant belongs, i.e., the participation function server, under such scene, the participation function server needs to send all the session modification requests received to the controlling function server for processing. In addition, the client receiving the group condition may perform some similar filtering processing.

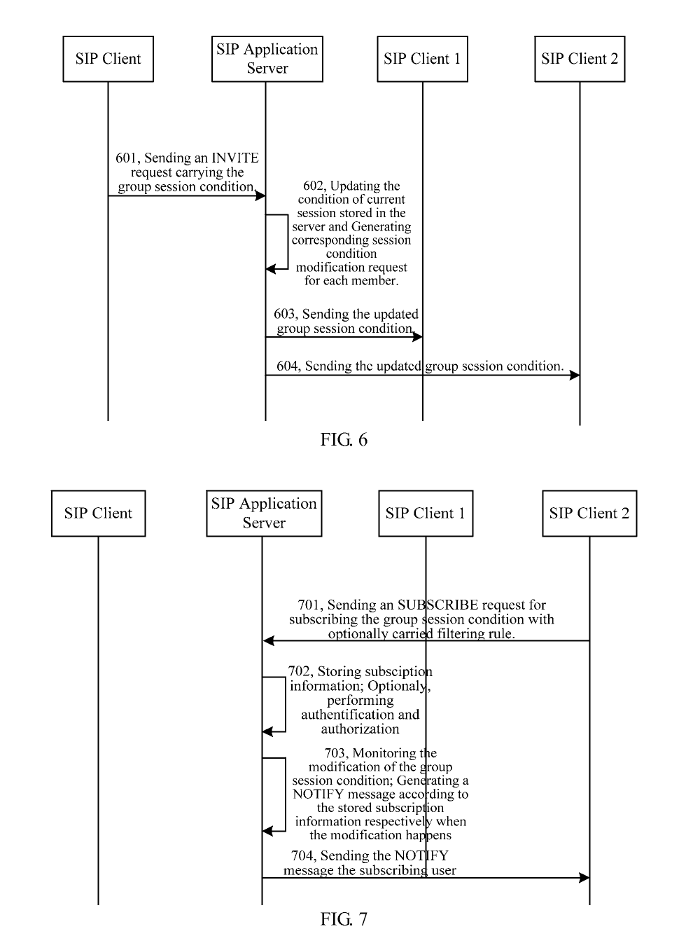

FIG. 6 is a flowchart illustrating the method for the session initiator to modify the group condition in accordance with the embodiment of the present invention. The network entities involved include: a session initiator (i.e., an SIP client), an SIP application server, a session participant (i.e., an SIP client 1 and an SIP client 2). The specific steps are as follows.

Step 601, in the session process, the SIP client sends an SIP re-INVITE request to the SIP application server. The SIP re-INVITE request carries the group session identity and the modified group condition.

In the embodiment of the present invention, the session participant, e.g., the SIP client 1 or the SIP client 2, may also send the SIP re-INVITE request to perform modification of the group condition. The application server may judge whether to allow the modification according to a corresponding authorization strategy (e.g., allowing the modification of the SIP client 1) or the request sent by the session participant. Optionally, the request is transferred to the session initiator for perform authorization. The application server returns the corresponding response to the session participant according to an authorization result.

Step 602, the SIP application server acquires the stored corresponding group condition according to the group session identity carried in the received request and performs updating.

If there needs to re-invite the member to change the media type of the multi-party communication after updating the group condition, the following steps may further performed.

Steps 603˜604, the SIP application server sends corresponding re-INVITE requests to session participants respectively. Furthermore, the re-INVITE request may further carry the updated group condition corresponding to each session participant.

In addition, the updated group condition may also be sent to each participating group member through a NOTIFY message. The specific steps are as shown in FIG. 7. FIG. 7 is a flowchart illustrating the method for the session participant to subscribe to the group condition in accordance with the embodiment of the present invention. The specific steps are as follows.

Step 701, during the session perform process, the SIP client 2 sends a SUBSCRIBE request to the SIP application server for subscribing to the group condition.

The SUBSCRIBE request is adapted to obtain a group condition modification notification when the group condition is modified. The SUBSCRIBE request may carry a filtering rule demonstrating which group condition's modification notification is desired to be received. For example, only the modification notification for the relevant condition of the confidential message or the number of group members allowed by the session is desired to be received.

Step 702, the SIP application server stores the subscription information of the SIP client 2 according to the received request.

Before storing the subscription information of the SIP client 2, the SIP application server may also perform authentification and authorization to the SIP client 2. After the authentification and the authorization are passed, the subscription information of the SIP client 2 may be stored.

Step 703, the SIP application server monitors the modification of the group condition. When a modification of the group condition is monitored, the SIP application server generates a NOTIFY message according to the stored subscription information. The NOTIFY message carries the updated group condition which is filtered according to the filtering rule.

Step 704, the SIP application server sends the NOTIFY message carrying the updated group condition to the SIP client 2.

FIG. 8 is a flowchart illustrating the method for performing the session under the scene of a pre-defined group session in accordance with the embodiment of the present invention. The specific steps are as follows.

Step 801, the session initiator, i.e., the SIP client, sends an SIP INVITE request carrying a pre-defined group identity.

Step 802, the SIP application server obtains the group member information and the group condition corresponding to the pre-defined group identity carried in the SIP INVITE request from a shared group management server (Shared Group XDMS, Shared Group XML Document Management System).

If the SIP application server has stored the group member information and the group condition corresponding to the pre-defined group identity carried in the SIP INVITE request, this step may be omitted.

If the SIP INVITE request in the step 801 also contains the group member information and the group condition, after combining with the group member information and the group condition corresponding to the pre-defined group identity, a follow-up step is executed. The specific combination method is to perform a set union operation to the group member and perform a logical “AND” operation to the group condition.

Steps 803˜807 are the same as the steps 302˜306 in FIG. 3.

Step 808, during the session process, the SIP client sends an SIP re-INVITE request carrying a modified group condition.

Step 809, the SIP application server updates the stored current session group condition. Optionally, for the session participant, the SIP application server may generate a corresponding session condition modification request, e.g., an SIP INVITE request to modify the media type of the session. Or, the session modification request contains a newly added group member, the SIP application server sends the SIP INVITE request to invite the newly added member to participate in the group session. If it is set in the updated group condition that a member participating in the session is not allowed to continue participating in the session, the application server may send a forbidding (BYE) request to the member's client and disconnect the client.

Two specific embodiments are taken as examples for explanation.

### Embodiment 1

Alice invites 5 classmates to perform an IM chat. She only hopes to allow these 5 classmates to invite some friends for participating the session but does not hope to allow the newly invited friends to further invite others to participate in their chat. At the same time, she determines that the total number of chatting participants should not exceed 10, all the chatting participants should not be anonymous, no subconference is allowed, no confidential message transmission is allowed, and the conference topic should be “Merry Xmas and Happy New Year!”. The format of the SIP INVITE request initiated by Alice is as follows:

INVITE sip:conf-fact@example.com SIP/2.0
Via: SIP/2.0/TCP atlanta.example.com

; branch=z9hG4bKhjhs8ass83

Max-Forwards: 70
To: “Conf Factory” <sip:conf-fact@example.com>
From: Alice <sip:alice@example.com>;tag=32331
Call-ID: d432fa84b4c76e66710
CSeq: 1 INVITE
Contact: <sip:alice@atlanta.example.com>
Allow: INVITE, ACK, CANCEL, BYE, REFER
Allow-Events: dialog
Accept: application/sdp, message/sipfrag
Require: conference-policy-invite
Content-Type: multipart/mixed; boundary=“boundary1”
Content-Length: XXX ( filled with the real length of the message body )
--boundary 1
Content-Type: application/conference-policy+xml
Content-Disposition: conference-policy
<?xml version=“1.0” encoding=“UTF-8”?>
<list-service>

<list>

<entry uri=“sip:bill@example.com” copyControl=“to” />
<entry uri=“sip:randy@example.net” copyControl=“to” />
<entry uri=“sip:eddy@example.com” copyControl=“to” />
<entry uri=“sip:joe@example.org” copyControl=“cc” />
<entry uri=“sip:carol@example.net” copyControl=“cc” />

</list>
<display-name xml:lang=“en-us”>Friends</display-name>
<max-participant-count>10</max-participant-count>
<subject>Merry Xmas and Happy New Year!</subject>
<ruleset>

<rule id=“a7c”>

<conditions>

<is-list-member/>

</conditions>
<actions>

<join-handling>true</join-handling>
<allow-anonymity>true</allow-anonymity>
<allow-subconf>false</allow-subconf>

<allow-private-message>false</allow-private-message>

<allow-invite-users>true<allow-invite-users>

</actions>

</rule>

</ruleset>

</list-service>
--boundary1-

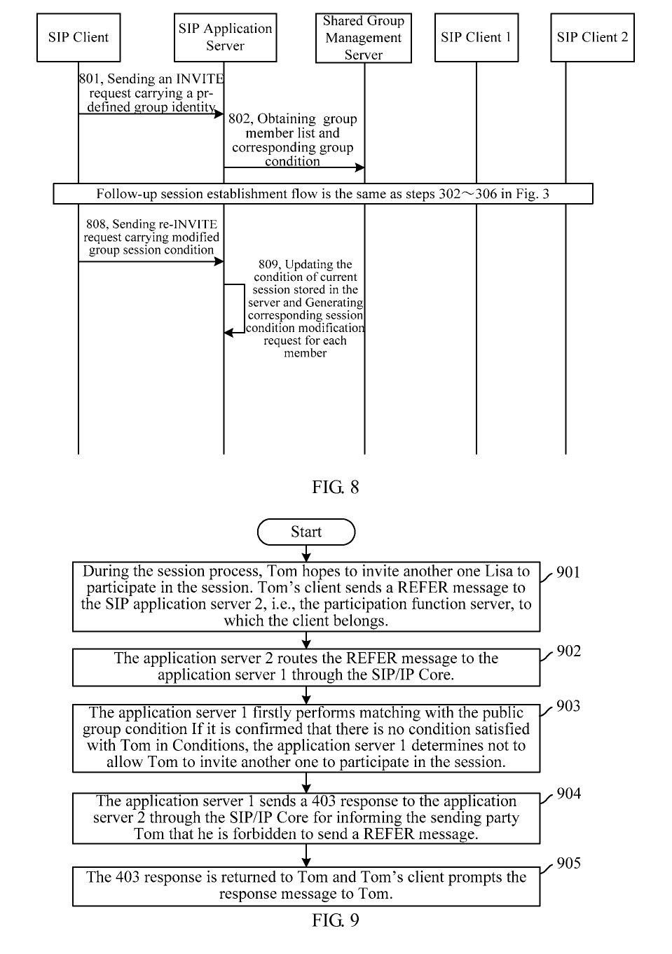

FIG. 9 is a flowchart illustrating the method of the processing for the SIP client 2, i.e., a friend Tom invited by a classmate in the session process for participation, tries to invite another one to participate in the session in accordance with a preferable embodiment of the present invention. The specific steps are as follows.

Step 901, during the session process, Tom hopes to invite another one Lisa to participate in the session. Tom's client sends a REFER message to the SIP application server 2, i.e., the participation function server, to which the client belongs. A field of REFER-TO in the REFER message is designated as Lisa's SIP URI.

Step 902, the application server 2 routes the REFER message to the controlling function server, i.e., the application server 1 through the SIP/IP Core.

Step 903, the application server 1 firstly performs matching with the public group condition to check whether the number of chatting participants has achieved an upper limit. Then, the application server 1 performs matching with the group condition for Tom. If the application server 1 confirms that Tom does not satisfy any of the Conditions, the application server 1 determines not to allow Tom to invite another one to participate in the session.

Step 904, the application server 1 sends a 403 response (Not allowed) to the application server 2 through the SIP/IP Core for informing the sending party Tom that he is not allowed to send a REFER message.

Step 905, the 403 response is returned to Tom and Tom's client prompts the response message to Tom.

The technical solution shown as FIG. 9 adopts a Content-Type: application/conference-policy+xml including a group member list and a group condition. Another implementing solution is to register a new Content-Type only adapted to carry the group condition which may be used in combination with the existing group member list Content-Type: application/resource-lists+xml; or may be used independently. For example, when the group condition is updated during the session process, the INVITE message sent by the client does not need the group member list. It is enough to carry the group condition.

### Embodiment 2

Alice invites 5 workmates to hold a phone conference and sets conference participation conditions for them respectively. During the conference, a member A hopes to subscribe to a conference group condition he cares. The format of the SUBSCRIBE request sent by him is as follows:

SUBSCRIBE is a conference ID assigned by a conference server during establishing a session.

Via: SIP/2.0/TCP memberhost.example.com; branch=z9hG4bKnashds7
To: ConferenceID assigned by the conference server during establishing
the session
From: <sip:bill@example.com>;tag=xfg9
Call-ID: 2010@memberhost.example.com
CSeq: 17766 SUBSCRIBE
Max-Forwards: 70
Event: conference-rules
Accept: application/conference-rule-info+xml
Contact: <sip:bill@example.com>
Expires: 600
Content-Length: 0

The conference server, i.e., the SIP application server, judges whether the member A is allowed to subscribe to the conference group condition according to the conference's group condition. If the member A is allowed, a NOTIFY is used to return the group condition. In addition, the follow-up session group condition is modified; the application server may send a notification message. The format of the notification message is as follows:

NOTIFY sip:bill@example.com SIP/2.0

Via: SIP/2.0/TCP conference.example.com;branch=z9hG4bKna998sk
From: Conference Server <sip:conf34@example.com>;tag=ffd2
To: <sip:bill@example.com>;tag=xfg9
Call-ID: 2010@conference.example.com
Event: conference-rules
Subscription-State: active; expires=599
Max-Forwards: 70
CSeq: 8775 NOTIFY
Contact: <sip:conf34@conference.example.com>
Content-Type: application/conference-rule-info+xml
Content-Length: ...
<?xml version=“1.0” encoding=“UTF-8”?>
<conference-rule-info>

<display-name xml:lang=“en-us”>Friends</display-name>

<max-participant-count>10</max-participant-count>
<subject>My conference</subject>

<actions>

<allow-refer-users>TRUE</allow-refer-users>

<allow-remove-users> FALSE</allow-remove-users>

</actions>

</conference-rule-info>

The notification message contains the message body of Content-Type: application/conference-rule-info+xml. The public group condition part of the application server's group condition may be used directly. However, the group condition for a given group member is not put in the notification message intact. Instead, the corresponding <actions> corresponding to the condition satisfied by the subscriber is obtained according to <conditions> and only the matched corresponding content of <actions> is put into the notification message to be sent to the subscriber. In addition, if the group condition is carried in the SIP INVITE message sent by the application server to the participant, the above mentioned method may also be adopted.

The embodiment of the present invention may not only be applied in the scene that the above mentioned SIP INVITE carries the group condition, but may also be applied in the scene of publish (SIP Publish) presence information or other scenes. The SIP Publish message is used to publish the presence information onto the presence server. The publish message carries the authorization information (in the conventional technology, only the presence information may be carried instead of the authorization information). The authorization information may be constructed by adopting a common policy structure similar to the above mentioned group condition for a given group member. Therefore, the presence server may authorize a watcher's subscription of the presence information according to the authorization information. Besides the presence information, the publishment of some other event states may also be performed by carrying the authorization information in the Publish message so as to control the subscription authorization of the event state information. Therefore, there is no need for the client to set the authorization information on the server through other modes. The client may directly set the authorization information at the same time of the publishment.

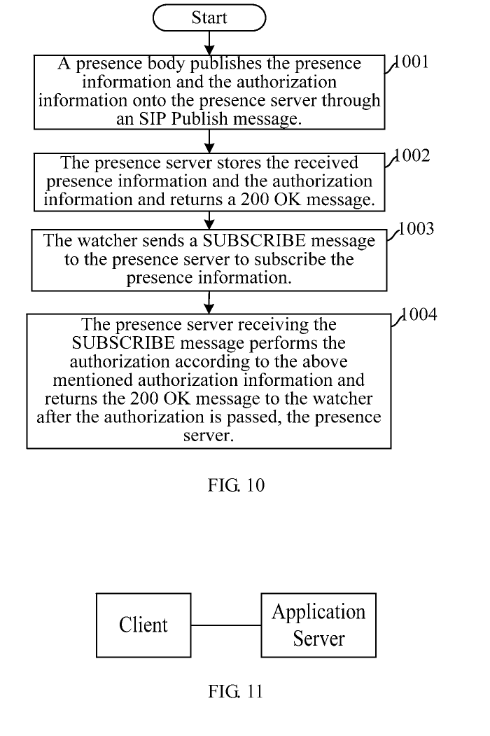

As shown in FIG. 10, FIG. 10 is a flowchart illustrating the method applied in the publication scene for subscribing to the presence information in accordance with the embodiment of the present invention. The specific steps are as follows.

Step 1001, a presence body publishes the presence information and the authorization information onto the presence server through an SIP Publish message.

The presence information and the authorization information use different Content-Type, such as application/pidf+xml and application/pres-rules+xml. The Publish message is similar to the INVITE message. Hereby, only the content of authorization information is taken as an example as follows:

<?xml version=“1.0” encoding=“UTF-8”?>

<ruleset><rule id=“1”>

<conditions>

<identity><id
entity=“user@example.com”/></identity>

</conditions>
<actions><sub-handling>allow</sub-handling></actions>
<transformations>

<provide-services>

<service-uri-scheme>PoC</service-uri-scheme>
<service-uri-scheme>IM</service-uri-scheme>

</provide-services>
<provide-persons><all-persons/></provide-persons>

</transformations>

</rule></ruleset>

Step 1002, the presence server stores the received presence information and the authorization information and returns a 200 OK message.

If the presence server receives the presence information published by the presence body again but does not receive the authorization information at the same time in a follow-up flow, the presence server may continue to use the authorization information stored before for authorization; if the presence server receives the authorization information at the same time, the presence server updates the authorization information stored before.

Step 1003, the watcher sends a SUBSCRIBE message to the presence server to subscribe to the presence information.

Step 1004, the presence server receiving the SUBSCRIBE message, according to the above mentioned authorization information, performs the authorization. After the authorization is passed, the presence server returns the 200 OK message to the watcher.

The event state published by a PUBLISH message generally has an expiration date. Together with the event state, the authorization information may use the same expiration date. Certainly, the authorization information published by the PUBLISH message may not use the expiration date designated in the PUBLISH message. The authorization information may be valid all the time until new authorization information is received.

The PUBLISH message sent by the client may also only contain the authorization information. By now, the server may determine that the authorization information is set for which kind of event states in the Request-URI resource according to the Event header field in the PUBLISH message. For example, the Event field being presence represents that the authorization information is set for the resource presence information. This kind of authorization information may be valid all the time. The Expires header field in the PUBLISH message does not influence the authorization information.

One embodiment of the present invention further provides a system for performing multi-party communication. As shown in FIG. 11, the system includes an application server and at least one client.

The application server is adapted to receive the multi-party communication requests carrying the group condition sent by the client, store the group condition, perform centralized controlling over the session of the multi-party communication according to the group condition after establishing the multi-party communication, and process the multi-party communication session modification request sent by the client.

The client is adapted to send the multi-party communication requests carrying the group condition to the application server and send the multi-party communication session modification request to the application server.

In the embodiment of the present invention, the application server is also adapted to send a multi-party communication requests carrying the group condition for the client to clients except the client initiating the multi-party communication and add the client into the multi-party communication after the client returns a response.

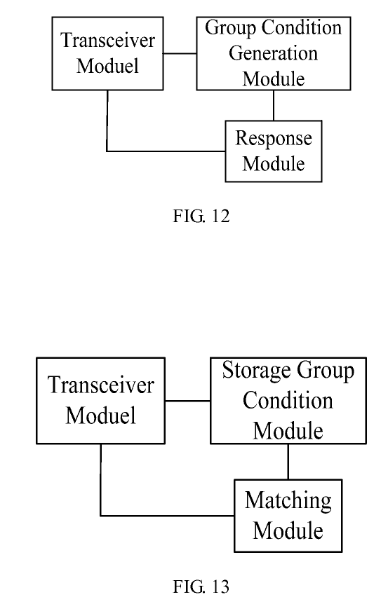

One embodiment of the present invention further provides a client for performing multi-party communication. As shown in FIG. 12, the client includes a transceiver module and a group condition generation module.

The group condition generation module is adapted to generate the group condition of the multi-party communication and send the group condition to the transceiver module.

The transceiver module is adapted to carry the group condition received from the group condition generation module on a multi-party communication requests and send the multi-party communication requests.

The client further includes a response module adapted to generate a response message after receiving the multi-party communication requests or a modification multi-party session request from the transceiver module and send the response message via the transceiver module.

The transceiver module is adapted to receive the multi-party communication requests or the modification multi-party session request and send it to the response module.

One embodiment of the present invention further provides a server for performing multi-party communication. As shown in FIG. 13, the server includes: a transceiver module, a storage group condition module and a control module.

The transceiver module is adapted to send the carried group condition to the storage group condition module after receiving the multi-party communication requests carrying the group condition, transfer the request to the control module for processing, and send out the received response message sent by the control module. Similarly, after receiving the multi-party communication modification request carrying the updated group condition, the transceiver module may send the updated group condition to the storage group condition module and send the request to the control module.

The storage group condition module is adapted to receive the group condition from the transceiver module for storage and provide the group condition for the control module during the multi-party communication process.

The control module is adapted to control the session of the multi-party communication according to the group condition obtained from the storage group condition module. The specific processing is to transfer different kinds of multi-party communication requests from the transceiver module, perform processing according to the group condition, and send the response message to the transceiver module.

Though illustration and description of the present disclosure have been given with reference to preferred embodiments thereof, it should be appreciated by persons of ordinary skill in the art that various changes in forms and details can be made without deviation from the spirit and scope of this disclosure, which are defined by the appended claims.

What is claimed is:

1. A method for performing a multi-party communication, comprising:
receiving a multi-party communication request carrying a group condition of the multi-party communication; and
controlling over the multi-party communication according to the group condition.

2. The method according to claim 1, further comprising:
generating the multi-party communication request for each of multi-party communication participants according to the group condition, sending the multi-party communication request to the multi-party communication participants, respectively; and
adding the multi-party communication participants into the multi-party communication according to response messages of the multi-party communication participants.

3. The method according to claim 2, after receiving the multi-party communication requests, further comprising:
establishing the multi-party communication with an initiator sending the multi-party communication request; and
storing the group condition after obtaining the group condition of the current multi-party communication from the multi-party communication request.

4. The method according to claim 2, wherein a message body carried in the multi-party communication request for each of the multi-party communication participants is generated according to the group condition of the multi-party communication participants; when the multi-party communication of a temporary group is established, the group condition includes a group condition of the current multi-party communication carried in the received multi-party communication request;
when the multi-party communication of a pre-defined group is established, the group condition is generated by combining or substituting the stored group condition with the group condition of the current multi-party communication carried in the received multi-party communication request.

5. The method according to claim 1, further comprising:
during a multi-party communication process, receiving a multi-party communication modification request carrying an updated group condition, obtaining the group condition from the multi-party communication modification request, and updating the group condition of the multi-party communication.

6. The method according to claim 5, wherein updating the group condition of the multi-party communication comprises substituting or combining the group condition;
the multi-party communication modification request further comprises an instruction for combining or substituting the group condition;
the method further comprising updating the group condition according to the instruction.

7. The method according to claim 5, wherein the multi-party communication modification request for updating the group condition further carries a newly added group member list;
the method further comprises: generating a new multi-party communication request for newly added multi-party communication participants in the newly added group member list and sending the new multi-party communication request to the newly added multi-party communication participants respectively.

8. The method according to claim 5, after updating the group condition, further comprising at least one of:
generating a modification multi-party communication request for each of the multi-party communication participants and sending the modification multi-party communication modification request to the multi-party communication participants respectively; and
generating a multi-party communication disconnection request when the group condition includes forbidding at least one of the multi-party communication participants to participate in the multi-party communication, and sending the multi-party communication disconnection request to the at least one of the multi-party communication participants not allowed to participate in the multi-party communication.

9. The method according to claim 8, wherein a message body carried in the multi-party communication modification request for each of the multi-party communication participants is set according to the group condition of the given multi-party communication participants; during the multi-party communication of a temporary group, the group condition includes the group condition of the multi-party communication carried in the received multi-party communication request;
during the multi-party communication of the pre-defined group, the group condition is generated by combining or substituting the stored group condition with the group condition of the current multi-party communication carried in the received multi-party communication request.

10. The method according to claim 1, wherein the received multi-party communication request further comprises a group member list of a temporary group or an identity of the pre-defined group; determining the multi-party communication participants according to the group member list of the temporary group or an identity of the pre-defined group carried in the received multi-party communication request,
wherein performing controlling over the multi-party communication includes performing controlling over the determined multi-party communication participants.

11. The method according to claim 10, further comprising storing a preset group condition corresponding to a pre-defined group identity;
combining or substituting the group condition with the preset group condition corresponding to the pre-defined group identity after obtaining the group condition from the multi-party communication request.

12. The method according to claim 2, wherein the multi-party communication request for each of the multi-party communication participants is generated by a controlling function server;
before sending the multi-party communication request to the multi-party communication participants respectively, the method further comprises: generating the multi-party communication request for each of the multi-party communication participants, respectively, sending the multi-party communication request to the participation function server to which the multi-party communication participators belong, transferring the multi-party communication request to the multi-party communication participants by the participation function server;
the adding the multi-party communication participants into the multi-party communication is controlled by the controlling function server;
before the controlling function server receives the response messages of the multi-party communication participants, the method further comprises:
transferring, by the participation function server, the response messages of the multi-party communication participants to the controlling function server.

13. The method according to claim 12, wherein the multi-party communication request for each of the multi-party communication participants comprises the group condition; the participation function server caches the group condition for filtering the multi-party communication request of each of the multi-party communication participants according to the group condition during the multi-party communication.

14. A system for performing a multi-party communication, comprising:
a client for transmitting at least one of a multi-party communication request carrying a group condition and a multi-party communication modification request; and
an application server for receiving the multi-party communication request obtaining the group condition in the multi-party communication request, establishing the multi-party communication corresponding to the group condition, performing a control function over the multi-party communication, and processing the multi-party communication modification request according to the group condition;

15. The system according to claim 14, wherein the application server comprises a controlling function server and a participation function server;
the controlling function server for obtaining the group condition of the multi-party communication request after receiving the multi-party communication requests; generating the multi-party communication request for the client; respectively sending the multi-party communication request to the participation function server to which the client belongs; and establishing the multi-party communication corresponding to the group condition after receiving a response message sent by the client;
the participation function server for sending the received multi-party communication request to the client and sending the received response message from the client to the controlling function server;
wherein the client receives the multi-party communication request for the client and sends the response message to the participation function server.

16. The system according to claim 14, wherein the participation function server caches the group condition carried in the multi-party communication request for filtering the multi-party communication request of each of the multi-party communication participants according to the group condition during the multi-party communication.

17. A client for performing a multi-party communication, comprising:
a group condition generation module for generating a group condition of the multi-party communication and transmitting the group condition;
the transceiver module for receiving the group condition, carrying the group condition on a multi-party communication request and transmitting the multi-party communication request.

18. The client according to claim 17, further comprising a response module for generating at least one of a response message after the transceiver module receives the multi-party communication request and a modification multi-party session request and for sending the response message via the transceiver module;
wherein the transceiver module receives and transmits at least one of the multi-party communication request and the modification multi-party session request to the response module.

19. A server for performing a multi-party communication, comprising:
a transceiver module for transmitting a group condition to after receiving a multi-party communication request carrying a group condition, transferring the multi-party communication request, and receiving and transferring a received response message;
a storage group condition module for receiving and storing the group condition transmitted from the transceiver module and transmitting the group condition during the multi-party communication; and
a control module for receiving the response message and the group condition and controlling a session of the multi-party communication according to the group condition obtained from the storage group condition module.

20. A method for publishing an event state, comprising:
after receiving a publication message including an event state of resources and authorization information, performing controlling over a subscription authorization of the event state of the resources according to the authorization information.
